(19) United States
(12) Patent Application Publication
(10) Pub. No.: US 2003/0058257 A1
(43) Pub. Date: Mar. 27, 2003

(54) Applying identifying codes to stationary images

(76) Inventor: Jia Hong Yin, London (GB)

Correspondence Address: Martin Fleit, Fleit, Kain, Gibbons, Gutman & Bongini P.L., Suite A201, 520 Brickell Key Drive, Miami, FL, 33131, US

(21) Appl. No.: 10/216,058

(22) Filed: Aug. 9, 2002

(30) Foreign Application Priority Data
Aug. 11, 2001 (GB) 0119675.7

(51) Int. Cl. G09G 5/00

(52) U.S. Cl. 345/629

(57) ABSTRACT

The invention relates to the application of identifying codes to stationary images, for example images of fine art, using a process known as watermarking, by means of which coded identification data are incorporated into proprietary visual images. A system is described whereby the identification codes remain detectable in, and retrievable from, watermarked images, even where the images have been changed or modified as a result of operations such as resizing, cropping and rotation. The system combines a reference code with an identification code and embeds the combined codes into a still image, and a scanning process, which may automatically switch between coarse and fine modes, is used to detect the reference code and to decode as an identification code, data located in conjunction with a detected reference code, utilizing respective modules for (a) modification detection, (b) image resumption and (c) decoding.

This invention relates to the application of identifying codes to stationary images, for example images of fine art.

It is well known that significant advantages are gained, in terms of protection against copying and fraud, by the incorporation of coded identification data into proprietary visual images. The code incorporation procedures are well established and are generally referred to as “watermarking”; the codes themselves thus being referred to as “watermarks”. Such watermarks need, of course to be readily retrievable from the images and to be robust against attempts to alter or remove them. In addition, it is extremely important, particularly when watermarking still images, that the watermarks are invisible.

This is a particular problem with still images, because such images are generally of higher intrinsic quality and value than moving images. They can also be studied at length and minutely, thus permitting viewers to detect any slight visual blemish associated with the presence of a watermark. Another significant consideration for still image watermarking is robustness against physical damage, since valuable works may be physically damaged if an attacker believes that, by doing so, any embedded watermark will be destroyed.

A known and effective watermarking technology has been developed by the applicant company, and is described, inter alia, in UK Patent Application No. 9502274.5. This technology operates on the basis of hiding the watermarks in textures of images and is highly effective in the above respects.

People may, however, use still images in different ways (i.e. hard and electronic copies) and with various changes and modifications (i.e. resizing, cropping and rotation). Even though the watermarks may survive such changes/modifications, and thus remain embedded in the images, the changes/modifications may make it difficult to recognize and/or detect the codes, or they may be difficult to decode. In such circumstances, even though some data may be decoded from the coded image, it is difficult to be certain that the decoded data is uniquely indicative of the embedded watermark. The automatic and correct decoding of watermarks from modified still images thus presents a significant challenge, which the present invention seeks to address.

According to the invention from one aspect, an identification system for still images comprises means for combining a reference code with an identification code and for embedding the combined codes into a still image, the embedded codes being located so as to be concealed by textures in the image, and means for scanning the image to detect the reference code and for decoding any identification code located in conjunction with a detected reference code.

Preferably the still image is converted to YUV format, and the reference and identification codes are inserted into the Y signal of the image and concealed in the textures of the image.

The reference code is preferably short so that the number of bits for the identification code can be relatively large.

Preferably, the reference code comprises no more than 3 bits.

It is further preferred that the decoder comprises respective modules for (a) modification detection, (b) image resumption and (c) decoding.

In a preferred embodiment, the module for modification detection operates by comparing a (possibly) modified and coded subject image with the original image.

Typical modifications comprise those related to the two-dimensional image domain, and it is thus preferred that the system is configured to detect size-change, cropping and rotation. It is thus further preferred that the system utilizes a respective sub-module for detection of each individual modification type, and/or a combination of submodules for detection of a combination of various modification types.

Known techniques for feature detection and feature matching may be used to find the corresponding features in both the modified image and the original image. A preferred technique for feature matching uses a correlation function to match selected features, such as corners of objects, extracted from the two images.

A parameter that is particularly conveniently be used to detect whether a subject image has been modified is the image size.

In the process of cropping detection, a preferred technique matches corresponding corners in the two images, and the co-ordinates of the corresponding corners.

A preferred technique for rotation detection may include rotation feature detection, rotation feature matching and analysis, to develop features that can be used to calculate the rotation angle, as well as image shifting against the original image. Corners are also a preferred feature for use in rotation detection.

Resumption of the subject image, to make it approximately resemble the original image, preferably utilizes respective image resumption techniques for image resizing, image addition and image rotation.

Preferably, the decoding means utilizes a decoder that can automatically search for the embedded reference and identification codes.

It is further preferred that, if a reference code is detected in the process of auto-search, any further code detected along with the reference code is presumed to be a true identification code.

The process of auto-search preferably utilizes a searching process having respective “coarse” and “fine” modes.

It is preferred that, whenever some data, which is not necessarily the reference code and watermark, is detected in operation in the “coarse” mode, the “fine” searching mode is implemented to detect the reference code.

In order that the invention may be clearly understood and readily carried into effect, one embodiment thereof will now be described, by way of example only, with reference to the accompanying drawings, of which:

FIG. 1 shows, in block diagrammatic form, an encoder for use in a system according to one example of the invention;

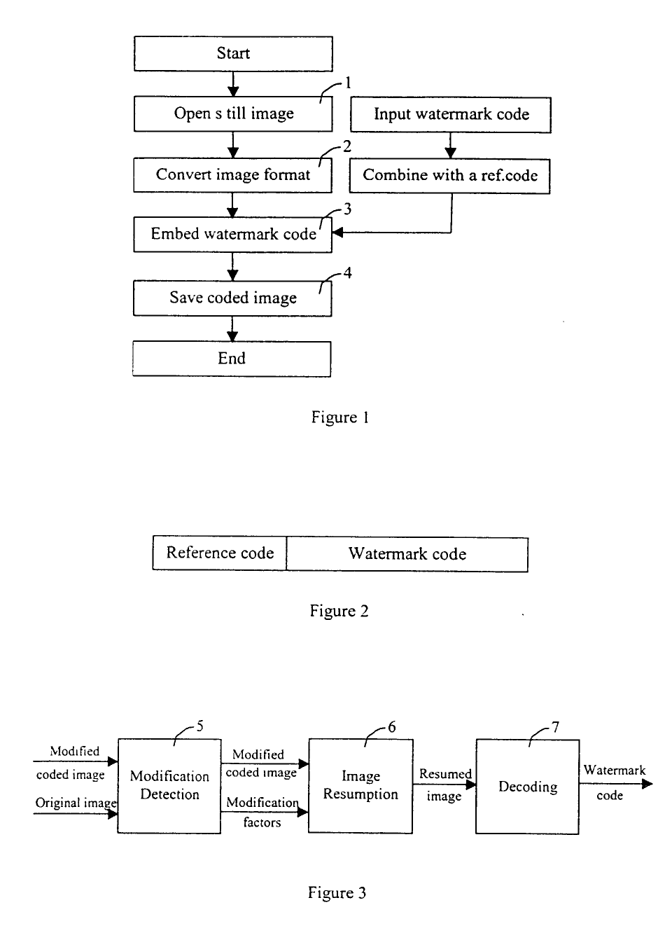

FIG. 2 shows, in outline, a format for combined reference and identification codes;

FIG. 3 shows, in block outline, elements of a still image decoder;

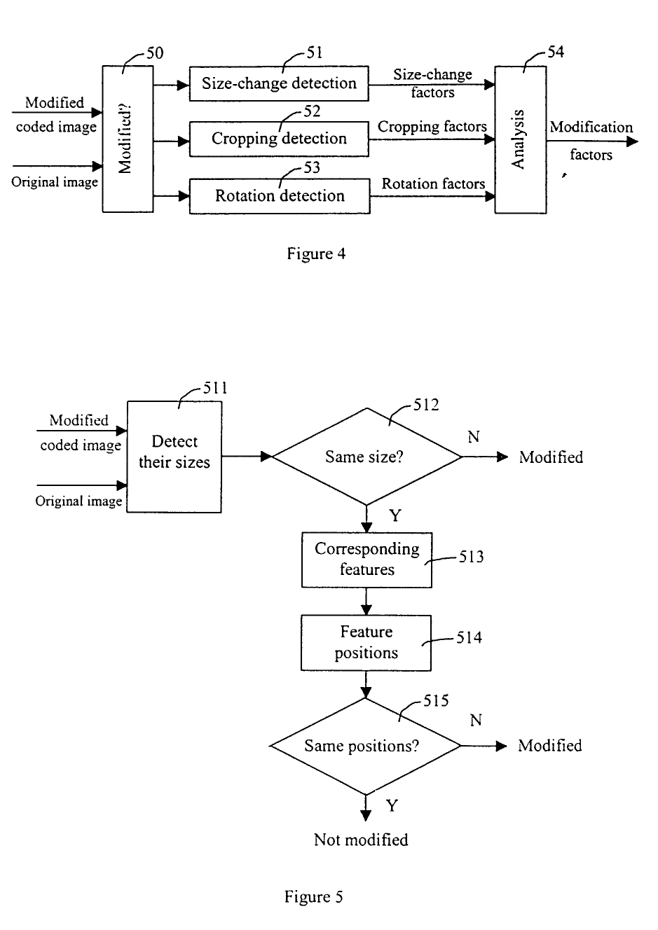

FIG. 4 shows, in block diagrammatic form, a process for detecting modifications that may have been made to a subject image;

FIG. 5 shows a flow diagram of a logical process for detecting image modifications;

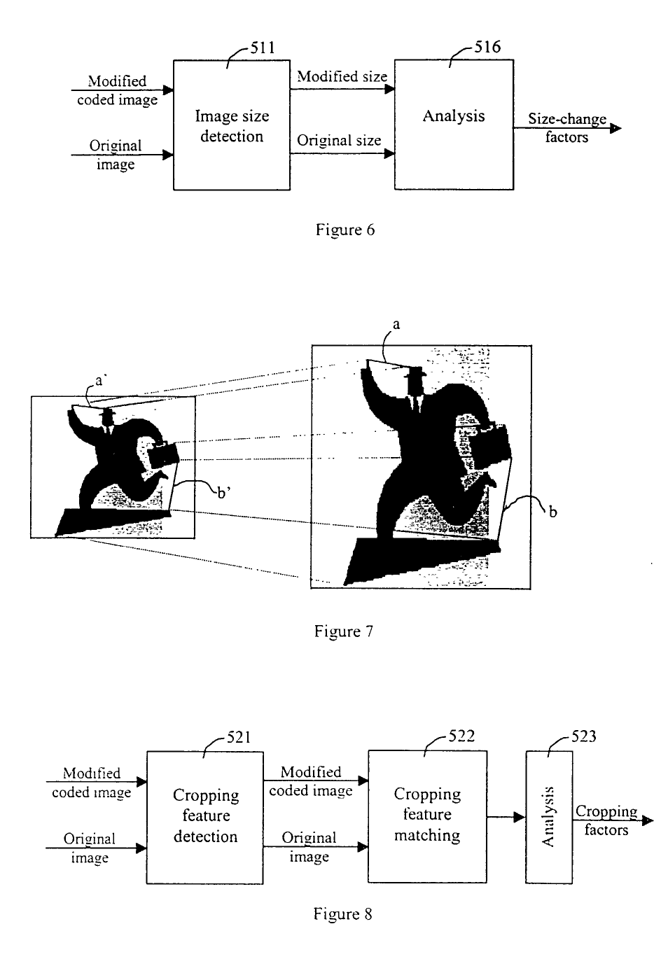

FIG. 6 shows, in block diagrammatic form, the operation of a module capable of detecting modifications in the form of size changes;

FIG. 7 shows pictorially how corner detection may be used to evaluate the scale of size changes;

FIG. 8 shows, in block diagrammatic form, the operation of a module capable of detecting modifications in the form of image cropping;

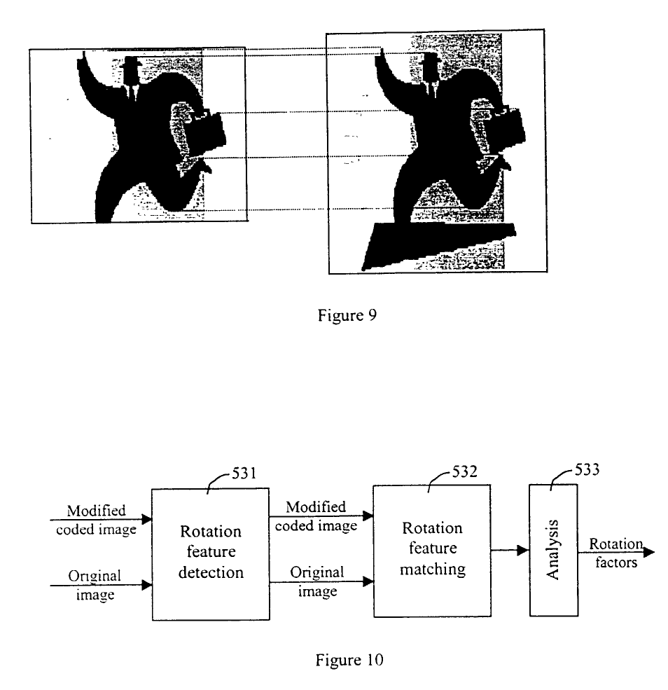

FIG. 9 shows pictorially how corner detection may be used to evaluate the extent of image cropping;

FIG. 10 shows, in block diagrammatic form, the operation of a module capable of detecting modifications in the form of image rotation;

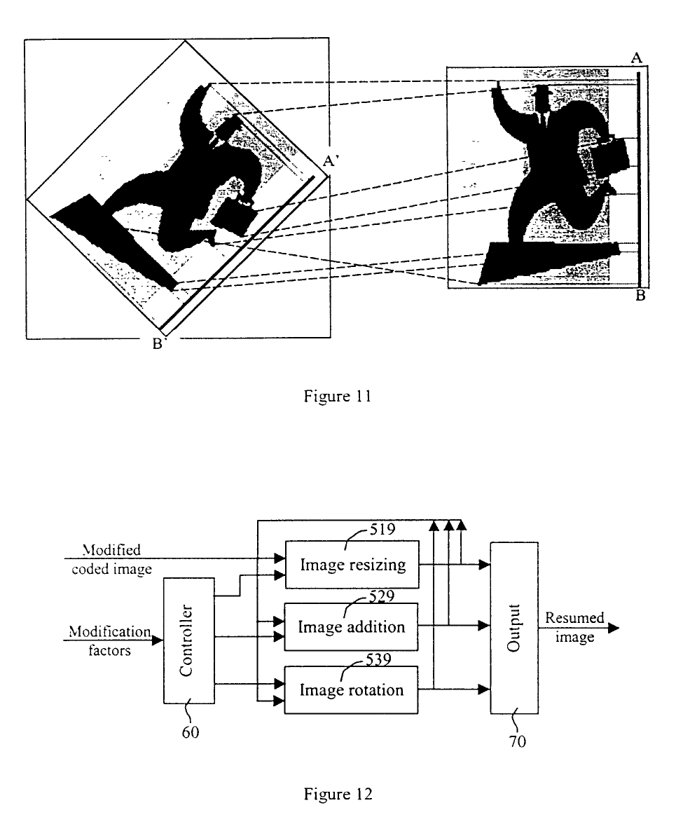

FIG. 11 shows pictorially how corner detection may be used to evaluate the extent of image rotation;

FIG. 12 shows, in block diagrammatic form, the processes used to cause a modified image to resume, at least approximately, its original form;

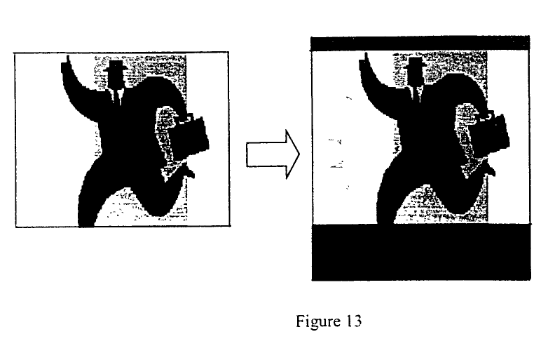

FIG. 13 shows pictorially the effect of causing a cropped image to resume substantially its original form; and

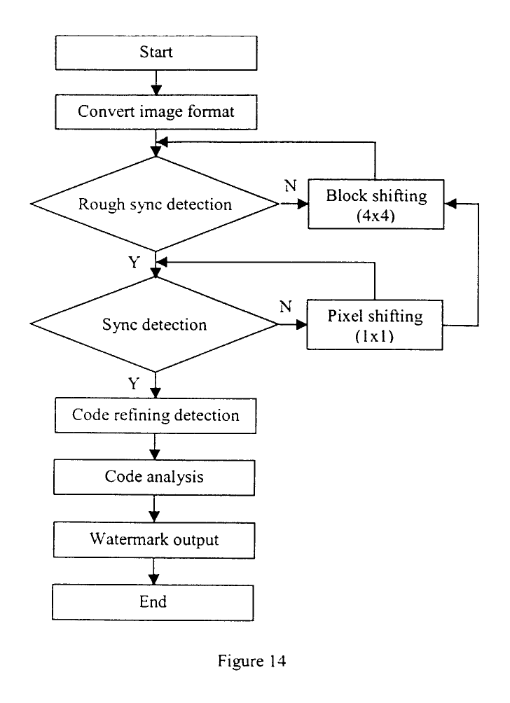

FIG. 14 shows a flow diagram indicating the decoding process.

Referring now to FIG. 1, this shows a block diagram for the watermark encoder. A still image to be watermarked and input to the encoder may be in any format, e.g. BMP, JPEG, GIF etc. The still image is opened at 1 and converted to YUV format at 2. In some cases, the image may be more easily converted to RGB format and then to YUV. The data code, comprising a reference code and a watermark, is inserted into the Y signal of the image at 3 by hiding it in the textures of the image domain. The embedded image is saved at 4 in any convenient format.

The format of data code to be embedded into images is shown in FIG. 2. Since the payload of the watermark code is related to its robustness, and there is a limit on the number of bits that can be embedded into the image, the reference code is preferably short so that the number of bits for the watermark can be as large as possible. For example, 3 bits (101) used as a reference code is reasonably short whilst being sufficiently reliable for decoding.

Since any one or more of several modifications may be made by people who want to use an image for their own purposes, it is very complicated in the decoder to automatically and correctly decode the embedded watermarks. The decoder, in this example of the invention, shown in FIG. 3, thus consists of three major modules, namely (a) modification detection 5, (b) image resumption 6 and (c) decoding 7.

In module 5, for modification detection, the original image (either with or without a watermark) is used as a reference image to detect the type and scale of any modifications. The modifications so detected are then used in module 6 to resume an image close to the original image. The resumed image is then applied as an input to the decoding module 7 where the embedded watermark code is decoded.

A typical construction for module 5 is shown in FIG. 4. A (possibly) modified coded image is compared at 50 with the original image to detect whether the image to be decoded has been modified and, if so, what type of modification has been made. There are many different modifications that may be made, however those related to the two-dimensional image domain are the most sensitive for the aforementioned watermarking technology of the applicant company; that technology being relatively sophisticated as regards modifications in intensity and colour, compression and conversion. The major modifications in the two-dimensional image domain include size-change, cropping and rotation, and thus three sub-modules, namely: size-change detection 51, cropping detection 52 and rotation detection 53, are provided to detect the individual modification factors. The outputs from the various detection submodules 51, 52 and 53 are analysed in a further module 54 to provide modification factors needed to “undo” the modifications detected.

The original image form having been at least approximately resumed, the watermark codes can be recovered therefrom and reliably decoded.

Complicated algorithms may be involved in the three submodules 51, 52 and 53 for modification detection. To detect these modifications, corresponding selected features that are present in both the modified coded image and the original image (which may or may not bear embedded codes) are detected first. The selected features may include edges, straight lines, corners, and patterns of pixel intensity, colours and so on. The major features in the original image or major features in a part of the original image should also, of course, be identifiable in the modified coded image, in order to provide reference points that can be utilized, for example by being aligned or overlain, to assist in the detection of two-dimensional changes to the original image.

Known techniques for feature detection and feature matching may be used to find the corresponding features in both the modified image and the original image. A common technique for feature matching uses a correlation function to match the features extracted from the two images. As an example, corners of objects are used here to detect modifications and their factors.

One parameter that can conveniently be used to detect whether a modification occurs in the image to be decoded is the image size. The size can be compared with that of the original image to easily decide whether the image has been enlarged or diminished. However, even if the size of the image to be decoded is the same as that of the original, a modification may have been made. Therefore, further analysis is needed to detect modification in this case.

FIG. 5 illustrates one procedure that can be used to determine whether the image has been modified in size. The sizes of the image to be decoded and the original image can easily be obtained from the image headers. If their sizes are different, it is of course evident that the image to be decoded has been modified, and that the modification at least includes a size change.

Even if the image sizes are the same, however, some other modification may have been made to the subject image. If this is the case, corresponding features need to be detected to analysis their positions. The position of a selected feature may be represented by its absolute coordinates in the image plane, and/or by its relative distances from other selected features in the image plane. If selected features in the subject image (the one to be decoded) are in the same positions as the corresponding selected features in the original image, no modification is detected. Otherwise, modification has been made to the image to be decoded.

FIG. 6 shows the procedure for size-change detection. If size-change is only made with re-sampling or resizing, the size-change factors can be obtained by comparing the size of the subject image to be decoded with that of the original image. However, multiple modifications may be made for the same image, e.g. cropping and size-change. Therefore, the technique of feature related size-change detection is developed.

As an example shown in FIG. 7, corresponding corners are first detected by corner detection and then matched. The distances between two pairs of detected corners are a and b in the original image. The distances between two corresponding pairs of detected corners in the subject image to be decoded are a′ and b′. Hence, the horizontal components of a and a′, aₓ and a′ₓ, are used to establish the horizontal size-change factor. The vertical components of b and b′, b_{y} and b′_{y}, are used to calculate the vertical size-change factor.

Cropping of images is also quite common. In general, unless the main features of an image remain in the cropped image, it is not necessary to discern the copyright. In the aforementioned watermark encoding technology of the applicant company, it is often the case that the data containing the watermark code still remains in an image that has been partly cropped. To decode the watermark code in the cropped image, the cropped part should be resumed. In the process of cropping detection shown in FIG. 8, the number of lines cropped vertically and the number of pixels cropped horizontally are detected and used for image resumption.

FIG. 9 shows the original image and a supposedly corresponding subject image that has, however, been cropped at the top and the bottom. By matching corresponding corners in the two images, the co-ordinates of the corresponding corners can be calculated. From the y coordinates, the number of lines cropped at the top and the number of lines cropped at the bottom can be calculated.

FIG. 10 shows the procedures for rotation detection, including rotation feature detection, rotation feature matching and analysis. The rotation features are image features that can be used to calculate the rotation angle. As an example, corners are detected as the rotation features in FIG. 11. Rotation feature matching is to match the corresponding rotation features in the subject image to be decoded and the original image. The module of analysis is to calculate the rotation angle against the original image.

FIG. 11 shows the original image and the subject image rotated from the original. To detect the rotation angle, a virtual line AB is established in the original image that is vertical and its function can be defined in the image plane. All the distances of the rotation features (corner in this example) to line AB are calculated. There is a corresponding virtual line A′B′ in the rotated image. Its function is unknown, but the distances from A′B′ to the corresponding corners are the same as those in the original image, and the distance functions are parallel. From the known distances from the corners to line A′B′ and the distance functions, the function of line A′B′ in the image plane can be calculated. The angle between the lines AB and A′B′ is the angle rotated.

FIG. 12 exemplifies a module that can be used to resume the original image from the modified (subject) image. It principally contains three image resumption techniques, named as image resizing, image addition and image rotation. The process of image resizing is to resume the original image from a size-changed image, based on the size-change factors. The process of image addition is to add extra lines and/or extra pixels into a cropped image so that it has the same size as that of the original image, based the cropping factors detected. An example is shown in FIG. 13 containing the added lines in black at the top and the bottom of the image. According to the rotation angle detected, the rotated image is oppositely rotated by the same angular amount to resume the image.

Since, as previously stated, more than one modification may have been made to the subject image to be decoded, one or more processes of image resumption may need to be applied to the same modified image. The controller that analyses the modification factors controls what resumption process(es) should be used. The output of this module is the fully resumed image and the input to the decoding module.

The decoding module is based upon a decoder that can automatically search for the embedded reference code and watermark code. If a reference code is detected in the process of auto-search, any further code detected along with the reference code is presumed to be the correct watermark code. The process of auto-search utilizes a searching process that moves from a “coarse” mode to a “fine” mode. The “coarse” searching mode is used to decode the images block by block (i.e. 4×4 pixels). Whenever some data, which is not necessarily the reference code and watermark, is detected in a block, the “fine” searching mode is implemented, pixel by pixel in the block, to detect the reference code. The process of search continues until the watermark code is decoded or through the entire image.

FIG. 14 shows, in block diagrammatic form, the decoding module. The input of the module is the output of the image resumption module. That is the resumed image (if any modification has been detected and compensated for) or the image to be decoded. The image is first converted into YUV format, in which Y contains the embedded data. In the process of rough sync detection, decoding is performed upon the image once in a block of 4×4 pixels. If some data is detected, the process of sync detection is continued. Otherwise, the image is shifted by a block of 4×4 pixels, and is then decoded. The process of block shifting and decoding continues until some data is decoded or until the end of the image is reached. The aim of the process of sync detection is to decode the reference code embedded in the image.

If the reference is decoded in the process of sync detection, the process of code refining detection is followed. Otherwise, the image is shifted 1 pixel and is decoded. The process of 1-pixel shifting and decoding continues until a reference code is decoded or until finishing the whole block of 4×4 pixels. If the reference code is not decoded at the end of the block, it reverts to the process of rough sync detection.

In the process of code refining detection, the process of decoding is implemented for every pixel in a neighbourhood of 5×5 pixels. At the end of the process, there are 25 possible watermark codes decoded. In the process of code analysis, the decoded 25 possible codes are analysed to decide the actual embedded watermark code. Hence, an accurate embedded watermark is decoded and output.

1. An identification system for still images comprising combining means for combining a reference code with an identification code and embedding means for embedding the combined codes into a still image, the embedding means being configured to conceal the combined codes within textures in the image, scanning means for scanning the image to detect the reference code and decoding means for decoding an identification code located in conjunction with a detected reference code, wherein the decoding means comprises respective modules for (a) modification detection, (b) image resumption and (c) decoding.

2. A system according to claim 1 further including conversion means for converting the still image to YUV format, and wherein the embedding means is configured to insert the reference and identification codes into the Y signal of the image.

3. A system according to claim 1 or claim 2 wherein the reference code comprises a relatively small number of bits and the identification code comprises a relatively large number of bits.

4. A system according to claim 3 wherein the reference code comprises no more than 3 bits.

5. A system according to claim 1 wherein the module for modification detection comprises means for comparing a subject image with an original image.

6. A system according to claim 1 wherein the module for modification detection is configured to detect any of: size-change, cropping and rotation.

7. A system according to claim 6 wherein the module for modification detection comprises a respective sub-module for detection of each individual modification type.

8. A system according to claim 5 wherein the module for modification detection includes matching means configured for feature detection and feature matching, and uses a correlation function to match selected features extracted from the two images.

9. A system according to claim 1 wherein the module for image resumption incorporates respective image resumption means configured to compensate for detected image resizing, image addition and image rotation.

10. A system according to claim 1 wherein the decoding means includes automatic searching means configured to automatically search for the embedded reference and identification codes.

11. A system according to claim 10 configured such that detection of a reference code during the automatic searching procedure leads to a presumption of a further code detected along with the reference code being a true identification code.

12. A system according to claim 10 wherein the automatic searching means includes means for implementing successive searches in “coarse” and “fine” modes respectively.

13. A system according to claim 12 wherein the automatic searching means is configured such that detection of potentially coded data during operation of the “coarse” mode triggers a search in the “fine” searching mode for the reference code.
